(19) United States
(12) Patent Application Publication
(10) Pub. No.: US 2018/0339667 A1
(43) Pub. Date: Nov. 29, 2018

(54) EXTERIOR WIRING HARNESS

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventors: Hiroomi Hiramitsu, Yokkaichi, Mie (JP); Ryouya Okamoto, Yokkaichi, Mie (JP); Hiroshi Shimizu, Yokkaichi, Mie (JP)

(21) Appl. No.: 15/546,289

(22) PCT Filed: Jan. 22, 2016
(86) PCT No.: PCT/JP2016/051798

§ 371 Date: Jul. 26, 2017

(30) Foreign Application Priority Data
Feb. 12, 2015 (JP) 2015-025413

(51) Int. Cl. B60R 16/02; H02G 3/04; H01B 7/08; B32B 5/26

(52) U.S. Cl. CPC B60R 16/0215; H02G 3/0487; B32B 5/08; H02G 3/0481; B32B 5/26; H01B 7/0838

(57) ABSTRACT

An exterior wiring harness 10 includes wires 11, a fibrous resin fabric 20 folded to enclose the wires 11 and bound with both end sides extending in a folding direction overlapped to project outward, and a shield layer 16 attached to an inner surface of the resin fabric 20.

### BACKGROUND

### 1. Field of the Invention

An exterior wiring harness is disclosed in this specification.

### 2. Description of the Related Art

Japanese Unexamined Patent Publication No. H11-353952 discloses a shield exterior member formed by adhering and fixing a metal foil to an entire thin flexible insulating resin sheet made of vinyl chloride or the like and winding the insulating resin sheet around a wire group with the metal foil located on an inner side.

In the case of routing wires in an environment where vibration occurs, such as in a vehicle, hitting sound may be generated when the wires contact another member. The hitting sound is uncomfortable to users. Thus, a silencing material may be wound around the wires as a measure against the hitting sound. However, if the silencing material is wound on the outside of the thin insulating resin sheet in the configuration of Japanese Unexamined Patent Publication No. H11-353952, a wiring harness becomes thicker, thereby causing a problem for wire routing in a narrow space.

The invention was completed based on the above situation and aims to provide an exterior wiring harness capable of shielding a wire and suppressing hitting sounds.

### SUMMARY

The invention is directed to an exterior wiring harness with a wire. A fibrous resin fabric is folded to enclose the wire and is bound with both sides extending in a folding direction overlapped to project out. A shield layer is attached to an inner surface of the resin fabric. According to this configuration, the shield layer is attached to the inner surface of the resin fabric folded to enclose the wire. Thus, the wire can be shielded by the shield layer. Further, enclosing the wire by the resin fabric suppresses the hitting sound due to the vibration of the wire due to the sound absorbing properties of the resin fabric. The resin fabric may have a thickness to have sound absorbing properties. However, both sides extending in the folding direction are overlapped to project out. Therefore, both sides of the resin fabric extending in the folding direction can be bound easily. Thus, it is possible to shield the wire and suppress hitting sound.

The sides of the resin fabric extending in the folding direction may be bound by welding. In this way, a configuration for binding the resin fabric can be simplified.

The shield layer is folded to enclose the wire and both sides thereof extending in a folding direction are bound together with the resin fabric. In this way, the both sides of the shield layer extending in the folding direction can be connected electrically.

The shield layer is a metal foil.

The shield layer is attached easily to the resin fabric, for example, as compared to the case where a braided wire formed of a multitude of metal thin wires is used as the shield layer.

A drain wire connected to ground potential may be connected to the shield layer.

According to present invention, it is possible to shield a wire and suppress hitting sound.

### BRIEF DESCRIPTION OF DRAWINGS

FIG. 1 is a plan view showing an exterior wiring harness of a first embodiment.

FIG. 2 is a section along A-A of FIG. 1.

FIG. 3 is a plan view showing a state where a shield layer is adhered onto a resin fabric.

FIG. 4 is a side view showing the state where the shield layer is adhered onto the resin fabric.

FIG. 5 is a perspective view showing a state where a drain wire is soldered to the shield layer adhered to the resin fabric.

FIG. 6 is a plan view showing a state where wires are placed on the shield layer adhered to the resin fabric.

FIG. 7 is a plan view showing an exterior wiring harness of a second embodiment.

### DETAILED DESCRIPTION

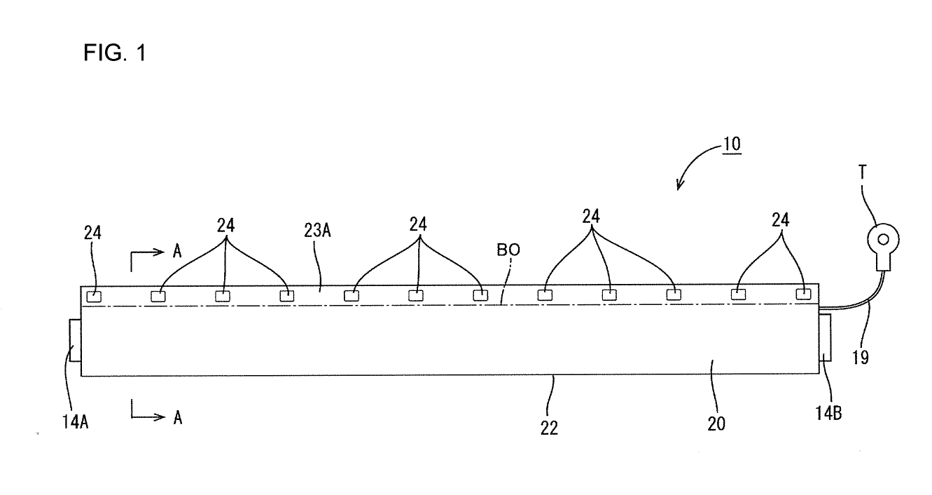

A first embodiment is described with reference to FIGS. 1 to 6.

An exterior wiring harness 10 of this embodiment can be used for example as a conductive path of a connection path between a battery pack (not shown) serving as a drive source of an electric or hybrid vehicle and a device (not shown) such as an inverter or motor. Note that the battery pack includes a battery module with a plurality of battery cells and an ECU (Electronic Control Unit) for managing and controlling voltages and the like of the battery cells.

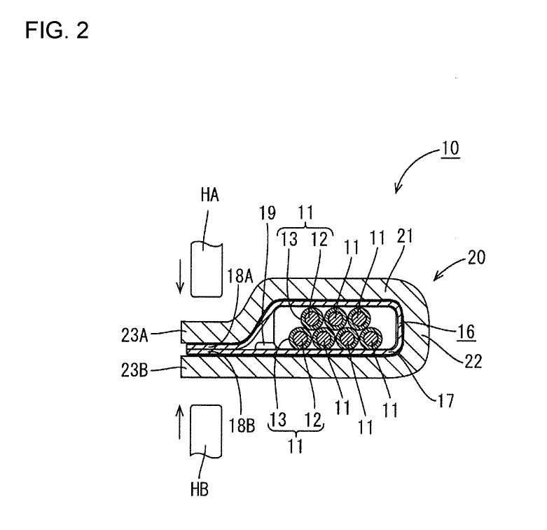

As shown in FIG. 2, the exterior wiring harness 10 includes wires 11 (seven in this embodiment), a resin fabric 20 for collectively enclosing the wires 11 and a shield layer 16 attached to an inner surface of the resin fabric 20. Each wire 11 is a coated wire having a circular cross-section and including a core 12 and an insulation coating 13 covering the periphery of the core 12. The core 12 is made of copper, copper alloy or aluminum alloy and may be a twisted wire formed by twisting a plurality of metal strands or a single-core wire.

The resin fabric 20 includes a tubular portion 21 for enclosing the wires 11 and binding portions 23A, 23B connected to the tubular portion 21 and overlapping each other and projecting outward to be bound. The tubular portion 21 is formed over the entire length of the resin fabric 20 in an extending direction of the wires 11 and is dimensioned to accommodate the plurality of wires 11 inside the shield layer 16. The tubular portion 21 is sufficiently flexible to be deformed easily in a direction corresponding to an external force, and includes a folded portion 22 folded to sandwich the wires 11 over the entire length in the extending direction of the wires 11. The folded portion 22 is formed on an end part opposite to the binding portions 23A, 23B in a circumferential direction of the tubular portion 21.

The binding portions 23A, 23B extend out (left in FIG. 2) in parallel and are formed on both end sides (tip sides) of extending parts of the resin fabric 20 respectively extending in a folding direction (left direction in FIG. 2) from the folded portion 22. A nonwoven fabric made of fibrous synthetic resin is used as the resin fabric 20. A nonwoven fabric is porous and in the form of a fiber sheet, a web (film-like sheet) or batting (blanket-shaped fibers) in which fibers are oriented in one direction or randomly. Further, a nonwoven fabric can be formed by joining or connecting fibers by welding, adhesion or the like electrically, mechanically, chemically or using a solvent or combining these.

A thickness of the resin fabric 20 is set such that a hitting sound that occurs when the resin fabric 20 contacts another member, such as a case of the battery pack, can be suppressed to an extent not to be felt uncomfortable by a user. This thickness is set according to a material. For example, aramid fibers, glass fibers, cellulose fibers, nylon fibers, vinylon fibers, polyester fibers, polyolefin fibers, rayon fibers and the like can be used as the material of the resin fabric 20.

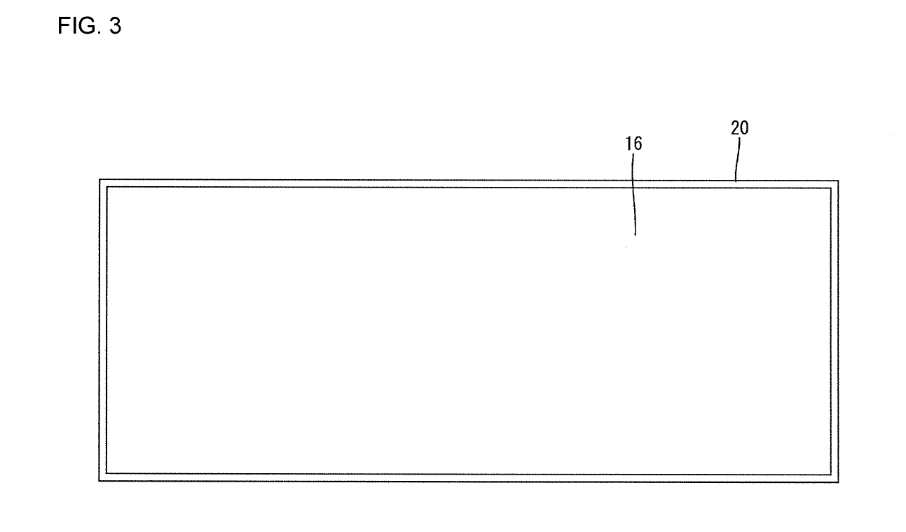

The shield layer 16 is formed of a thin metal foil and, in this embodiment, is made of aluminum or aluminum alloy. However, there is no limitation to this. For example, another metal foil such as foil made of copper or copper alloy may be used. The shield layer 16 includes a shield portion 17 for enclosing the wires 11 and connecting portions 18A, 18B provided on both end sides (tip sides) of extending parts of the shield portion 17 respectively extending in a folding direction and overlapping each other. The metal foil is overlapped with and adhered to substantially the entire inner surface of the resin fabric 20 except at an edge using an adhesive 15 (see FIG. 3).

Various adhesives can be used as the adhesive 15. The adhesive 15 may be an adhesive that is cured at room temperature or a thermosetting or thermoplastic adhesive. The adhesive 15 is applied to an upper surface side (inner surface side after folding) of the resin fabric 20. The adhesive 15 can be applied, for example, by spraying. However, the adhesive 15 can be applied by various other known methods. Adhesives of various viscosities can be used as the adhesive 15 and an adhesive having such a viscosity to penetrate into not only the upper surface of the resin fabric 20, but also the inside of the resin fabric 20 may be used.

A drain wire 19 is connected to the shield layer 16. The drain wire 19 may be a bare wire not covered at all, and one end is connected to the shield layer 16, such as by ultrasonic connection or soldering. As shown in FIG. 1, a round terminal T is connected to the other end of the drain wire 19.

The resin fabric 20 and the shield layer 16 are formed with welding portions 24 welded with ultrasonic waves. As shown in FIG. 2, the welding portions 24 are formed by sandwiching and ultrasonically welding the binding portions 23A, 23B from opposite outer sides by horns HA, HB. In this way, parts of the resin fabric 20 held in contact with the horns HA, HB are squeezed and parts of the metal foil of the shield layer 16 are connected by welding, thereby forming the welding portions 24. The welding portions 24 on the resin fabric 20 are deformed to become thinner and harder than the other parts. The welding portions 24 formed on the binding portions 23A, 23B are provided at predetermined intervals in the extending direction of the wires 11. Note that a boundary BO between the tubular portion 21 and the binding portion 23A is shown by dashed-dotted line in FIG. 1.

Connector portions 14A, 14B are connected to end parts of the wires 11. The connector portions 14A, 14B are connected to the cores 12 exposed by removing the insulation coatings 13 at the end parts of the respective wires 11, respectively arranged in openings on both ends of the tubular portion 21, exposed to outside and connectable to unillustrated mating connectors.

A method for manufacturing the exterior wiring harness 10 is described.

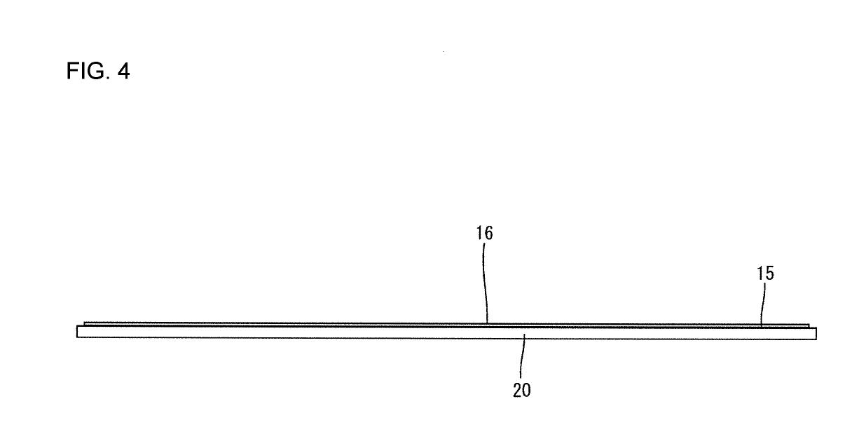

As shown in FIGS. 3 and 4, the adhesive 15 is applied onto the rectangular resin fabric 20 and the metal foil is adhered, thereby forming the shield layer 16.

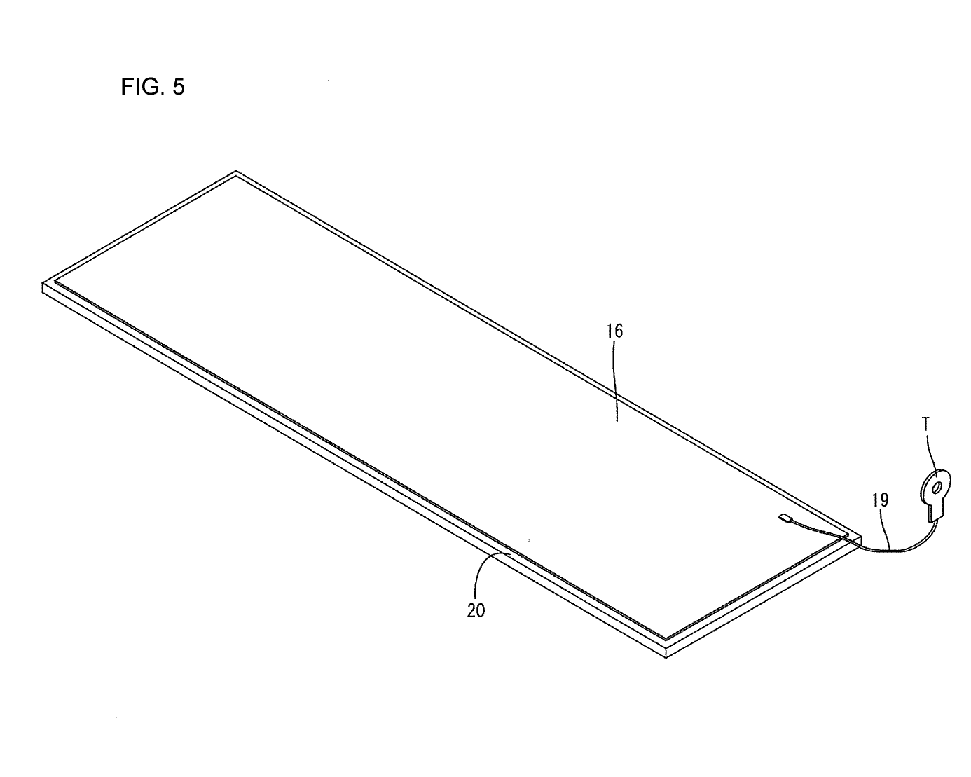

Subsequently, as shown in FIG. 5, the end part of the drain wire 19 is soldered to the shield layer 16.

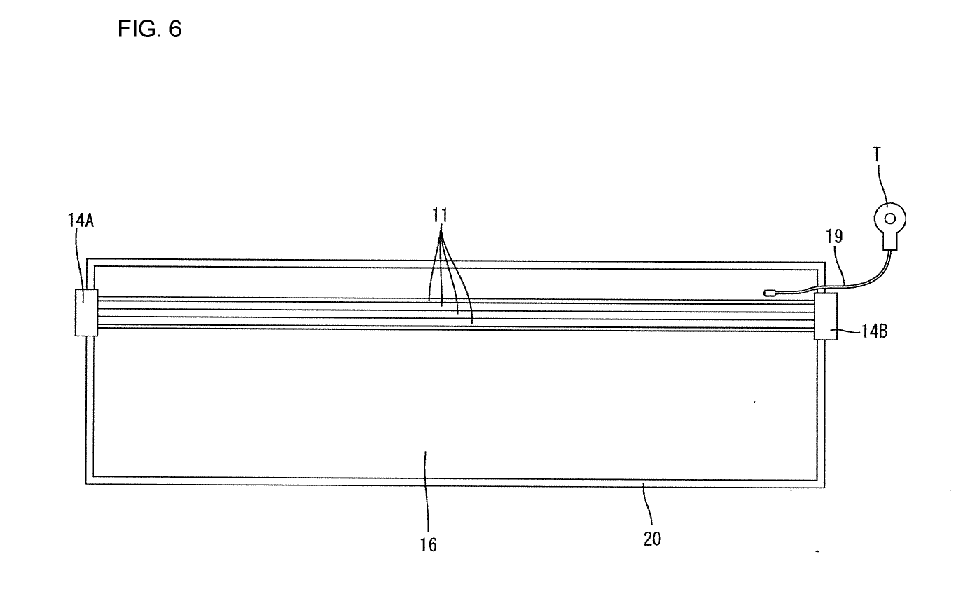

The wires 11 having the connector portions 14A, 14B connected to the end parts then are placed on the shield layer 16, as shown in FIG. 6. One end side (lower end side in FIG. 6) of the resin fabric 20 then is gripped and the resin fabric 20 is folded to sandwich the wires 11. Ultrasonic welding then is performed with the binding portions 23A, 23B, which are the overlapping end parts of the resin fabric 20 in the folding direction, sandwiched from outer sides by the horns HA, HB, thereby successively forming the welding portions 24. The binding portions 23A, 23B are bound to form the exterior wiring harness 10 by welding all the welding portions 24 (FIG. 1).

The exterior wiring harness 10 is arranged in a narrow space where the battery pack side in the connection path between the battery pack of the vehicle and the inverter, motor or other device is accommodated, and is bent according to a routing path.

According to this embodiment, the following functions and effects are exhibited.

According to this embodiment, the shield layer 16 is attached to the inner surface of the resin fabric 20 folded to enclose the wires 11. Thus, the wires 11 can be shielded by the shield layer 16. Further, the resin fabric 20 has sound absorbing properties. Therefore, enclosing the wires 11 by the resin fabric 20 suppresses hitting sounds due to the vibration of the wires 11, and a configuration can be simplified as compared to a configuration for suppressing hitting sound by covering a plastic protector with a silencing material. The resin fabric 20 has a thickness to have sound absorbing properties. However, the binding portions 23A, 23B on both end sides extending in the folding direction are overlapped to project outward. Thus, the binding portions 23A, 23B on both end sides of the resin fabric 20 extending in the folding direction can be bound easily so that it is possible to shield the wires 11 and suppress hitting sound.

Further, the binding portions 23A, 23B on both end sides of the resin fabric 20 extending in the folding direction are bound by welding.

In this way, a configuration for binding the resin fabric 20 can be simplified.

The shield layer 16 is folded to enclose the wires 11 and the connecting portions 18A, 18B on both end sides extending in the folding direction are bound together with the binding portions 23A, 23B of the resin fabric 20. In this way, both end sides of the shield layer 16 extending in the folding direction can be connected electrically.

Further, the shield layer 16 is a metal foil and therefore is attached easily to the resin fabric 20, as compared to the case where a braided wire formed of a multitude of thin metal thin wires is used as the shield layer 16.

Further, the drain wire 19 to be connected to ground potential is connected to the shield layer 16.

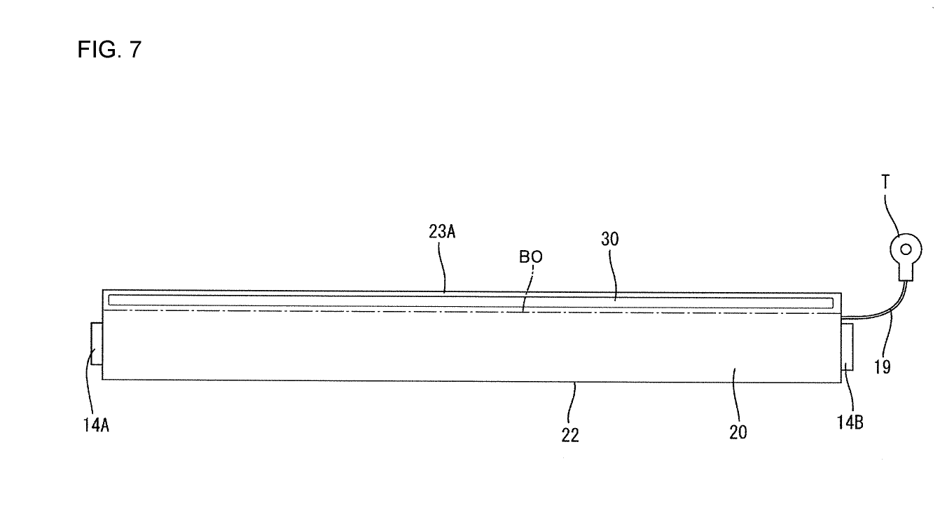

A second embodiment is described with reference to FIG. 7.

Although the welding portions 24 are formed intermittently in the first embodiment, welding portions 30 are formed over the entire length of a resin fabric 20 in the second embodiment. The other configuration is the same as in the first embodiment and the same components as in the first embodiment are denoted by the same reference signs and not described below.

The welding portions 30 are formed continuously formed over the entire length along an extending direction of wires 11 on binding portions 23A, 23B (although only the welding portion 30 on one binding portion 23A is shown in FIG. 7, the welding portion 30 is similarly formed also on the other binding portion 23B). The welding portions 30 are formed by ultrasonic welding.

The invention is not limited to the above described and illustrated embodiments. For example, the following embodiments also are included in the scope of the invention.

The number of the wires 11 is not limited to seven as described above, and may be another number. For example, there may be one wire 11. Further, the lengths of the wires 11 (length of the exterior wiring harness 10) can be changed according to the routing path.

The shield layer 16 is a metal foil. However, the shield layer 16 may be a braided wire formed by braiding a multitude of thin metal wires or a thin metal film coated on the inner surface of the resin fabric 20 by plating.

The binding portions 23A, 23B need not be bound by ultrasonic welding. For example, the binding portions 23A, 23B may be bound by heat welding by directly pressing a heat plate using a heater against a member. Further, U-shaped stables may be bent inwardly from both sides for binding using a stapler.

Although the welding portions 24 are arranged at equal intervals in the first embodiment, there is no limitation to this and the welding portions 24 may be arranged at different intervals.

### LIST OF REFERENCE SIGNS

10: exterior wiring harness
11: wire
15: adhesive
16: shield layer
20: resin fabric
21: tubular portion
22: folded portion
23A, 23B: binding portion
24, 30: welding portion

1. An exterior wiring harness, comprising:
a wire;
a fibrous resin fabric folded to enclose the wire and bound with both end sides extending in a folding direction overlapped to project outward; and
a shield layer attached to an inner surface of the resin fabric,
wherein:
the end sides of the resin fabric extending in the folding direction are bound;
the shield layer is a metal foil and parts of the metal foil are welded to each other; and
a connector portion is connected to an end of the wire and exposed from the resin fabric.

2. (canceled)

3. The exterior wiring harness of claim 1, wherein the shield layer is folded to enclose the wire and both end sides thereof extending in a folding direction are bound together with the resin fabric.

4. (canceled)

5. The exterior wiring harness of claim 1, wherein a drain wire to be connected to ground potential is connected to the shield layer.

6. The exterior wiring harness of claim 1, wherein a drain wire to be connected to ground potential is connected to the shield layer.
